(19) United States
(12) Patent Application Publication
(10) Pub. No.: US 2019/0226637 A1
(43) Pub. Date: Jul. 25, 2019

(54) ASSEMBLY AND DISASSEMBLY DEVICE FOR CEILING EQUIPMENT

(71) Applicant: Yangjun MAI, Huizhou (CN)

(72) Inventor: Yangjun MAI, Huizhou (CN)

(21) Appl. No.: 15/893,634

(22) Filed: Feb. 11, 2018

(30) Foreign Application Priority Data
Jan. 25, 2018 (CN) 201810073100.5
Jan. 25, 2018 (CN) 201820126950.2

(51) Int. Cl. F16M 13/02; F24F 7/007; H04R 1/02

(52) U.S. Cl. CPC F16M 13/027; F24F 7/007; F21V 21/03; F24F 2221/14; H04R 1/025

(57) ABSTRACT

The present disclosure provides an assembly and disassembly device for ceiling equipment. The device includes an inner frame, an outer frame, a leg, a pull rod, a transmission rod, a cover plate and an elastic sheet, wherein the outer frame is disc shaped and has the inner frame disposed therein, the outer frame has four legs disposed equally spaced at the periphery thereof, furthermore, the inner frame has the cover plate mounted therein, the cover plate has the transmission rod disposed thereon, and the transmission rod is connected to the pull rod, wherein the inner frame can be rotated so that the cover plate is driven to rotate, as a result the transmission rod drives the pull rod and the pull rod drives the leg to be clamped on a support plate mounted on a wall surface preset with a mounting hole.

### CROSS REFERENCE TO RELATED APPLICATIONS

The present application claims priority to Chinese Patent Application CN 201810073100.5 filed on Jan. 25, 2018 and to Chinese Patent Application CN 201820126950.2 filed on Jan. 25, 2018.

### TECHNICAL FIELD

The present disclosure relates to the technical field of assembly devices, and more particularly to an assembly and disassembly device for ceiling equipment such as light-fixtures, exhaust fans or ceiling loudspeakers, which realizes quick assembly by rotation of an inner frame.

### BACKGROUND

At present, ceiling equipment available on the market are mounted and fixed by bolts or springs. It is very troublesome to mount the ceiling equipment. It is needed to design a unique assembly and disassembly structure which realizes quick assembly by rotation of an inner frame, according to mechanical principles. According to the assembly and disassembly structure, a product can be quickly mounted by rotating the inner frame after the product is inserted into a reserved hole, and the product can be quickly demounted by rotating the inner frame; both time and labor are saved; and it is quick and convenient to mount and demount the product.

### SUMMARY

The present disclosure aims to provide an assembly and disassembly device for ceiling equipment such as light-fixtures, exhaust fans or ceiling loudspeakers, which realizes quick assembly by rotation of an inner frame, so as to solve the problem mentioned in the background above.

The present disclosure solves the above technical problem adopting the following technical schemes.

An assembly and disassembly device for ceiling equipment includes an inner frame (1), an outer frame (2), a leg (4), a pull rod (5), a transmission rod (6), a cover plate (7) and an elastic sheet (8), wherein the outer frame (2) is disc shaped and has the inner frame (1) disposed therein, the outer frame (2) has four legs (4) disposed equally spaced at the periphery thereof, furthermore, the inner frame (1) has the cover plate (7) mounted therein, the cover plate (7) has the transmission rod (6) disposed thereon, and the transmission rod (6) is connected to the pull rod (5), wherein the inner frame (1) can be rotated so that the cover plate (7) is driven to rotate, as a result the transmission rod (6) drives the pull rod (5) and the pull rod (5) drives the leg (4) to be clamped on a support plate (3) mounted on a wall surface preset with a mounting hole.

Preferably, the angle of rotation of the inner frame (1) is limited by the elastic sheet (8).

Preferably, the ceiling equipment includes light-fixtures, exhaust fans or ceiling loudspeakers.

Compared with the prior art, beneficial effects of the present disclosure are as follows. The present disclosure provides an assembly and disassembly device for ceiling equipment, which realizes quick assembly by rotation of the inner frame. The device has a novel structure. The present disclosure designs a unique assembly and disassembly structure according to mechanical principles. A product can be quickly mounted by rotating the inner frame after the product is inserted into a reserved hole, and the product can be quickly demounted by rotating the inner frame. Both time and labor are saved. It is quick and convenient to mount and demount the product.

Other features and advantages of the present disclosure are illustrated in the description hereinafter and partially become more apparent from the description or become understandable by implementing the present disclosure. The purpose and other advantages of the present disclosure can be realized and obtained through the structure specified in the description, claims and accompany drawings.

### BRIEF DESCRIPTION OF THE DRAWINGS

The present disclosure is described below in detail in conjunction with accompanying drawings, so that the above beneficial effects of the present disclosure become more apparent.

FIG. 1 is a structure diagram of an assembly and disassembly device for ceiling equipment according to the present disclosure.

FIG. 2 is a diagram of a leg fastener located by rotation in the application state of the assembly and disassembly device for ceiling equipment according to the present disclosure.

FIG. 3 is a structure diagram of a working state of the assembly and disassembly device for ceiling equipment according to the present disclosure.

FIG. 4 is an internal view of the assembly and disassembly device for ceiling equipment according to the present disclosure.

FIG. 5 is an external view of the assembly and disassembly device for ceiling equipment according to the present disclosure.

FIG. 6 is a side view of the assembly and disassembly device for ceiling equipment according to the present disclosure.

FIG. 7 is a working diagram of the assembly and disassembly device for ceiling equipment according to the present disclosure.

### DESCRIPTION OF THE EMBODIMENTS

Implementations of the present disclosure are described below in detail in conjunction with the drawings and embodiments, so as to make the implementation procedures how the present disclosure employs technical means to solve the technical problems and achieve the technical effects fully understood and implemented. It should be noted that each embodiment of the present disclosure and each feature in each embodiment can be combined mutually if no conflict is caused. All technical schemes formed are intended to be included in the scope of protection of the present disclosure.

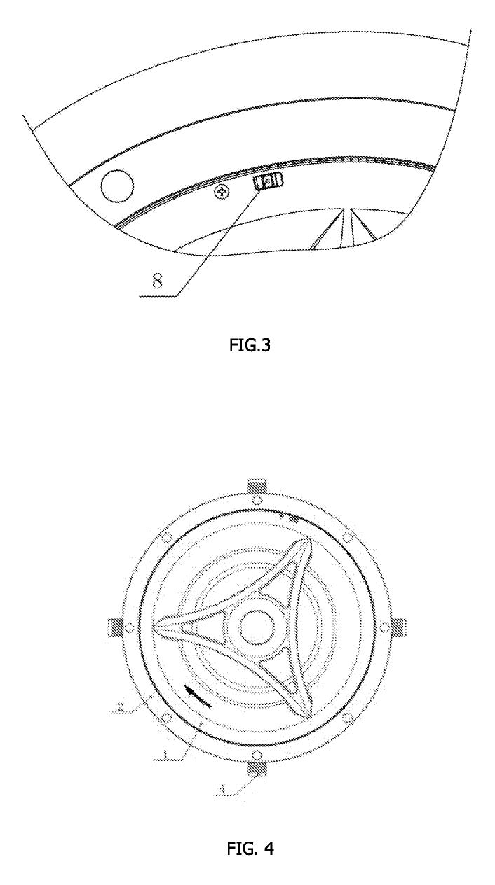

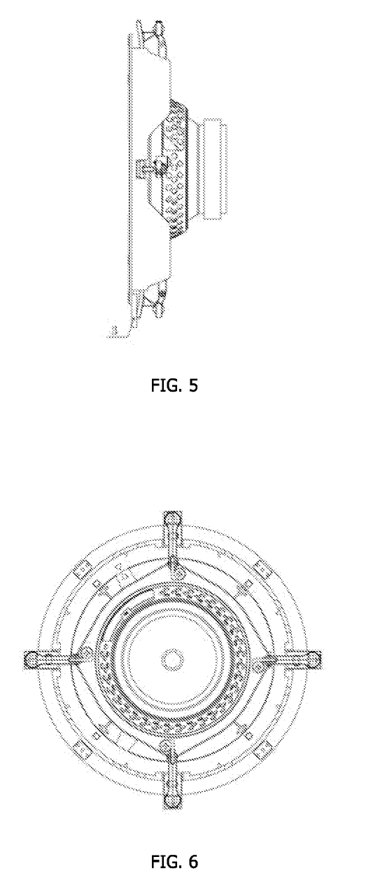

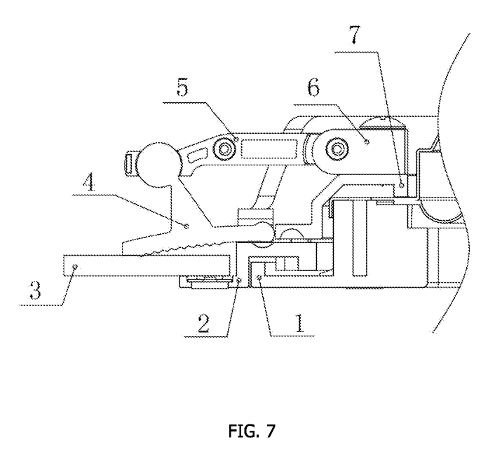

Referring to FIG. 1 to FIG. 7, an assembly and disassembly device for ceiling equipment includes an inner frame (1), an outer frame (2), a leg (4), a pull rod (5), a transmission rod (6), a cover plate (7) and an elastic sheet (8). The outer frame (2) is disc shaped and has the inner frame (1) disposed therein. The outer frame (2) has four legs (4) disposed equally spaced at the periphery thereof. Furthermore, the inner frame (1) has the cover plate (7) mounted therein. The cover plate (7) has the transmission rod (6) disposed thereon. The transmission rod (6) is connected to the pull rod (5). The inner frame (1) can be rotated so that the cover plate (7) is driven to rotate; as a result, the transmission rod (6) drives the pull rod (5) and the pull rod (5) drives the leg (4) to be clamped on a support plate (3) mounted on a wall surface preset with a mounting hole.

Preferably, the angle of rotation of the inner frame (1) is limited by the elastic sheet (8).

Preferably, the ceiling equipment includes light-fixtures, exhaust fans or ceiling loudspeakers.

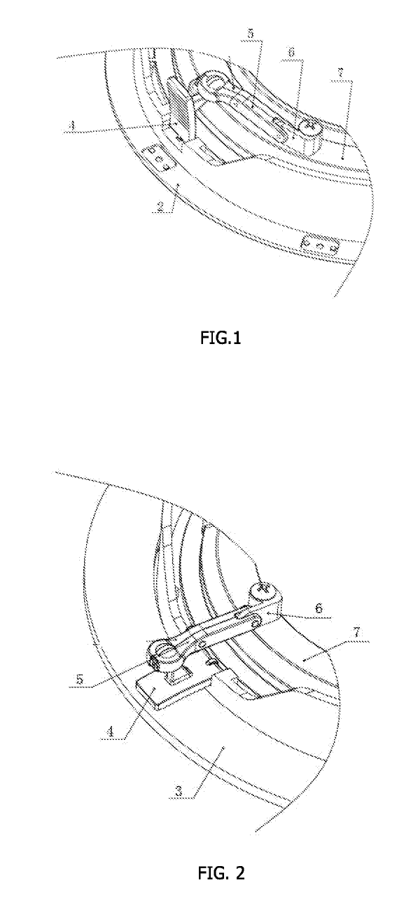

The working principle of the present disclosure is as follows. The present disclosure provides an assembly and disassembly device for ceiling equipment such as light-fixtures, exhaust fans or ceiling loudspeakers, which realizes quick assembly by rotation of an inner frame. The device has a novel structure. The present disclosure designs a unique assembly and disassembly structure according to mechanical principles. A product can be quickly mounted by rotating the inner frame after the product is inserted into a reserved hole, and the product can be quickly demounted by rotating the inner frame. Both time and labor are saved. It is quick and convenient to mount and demount the product. Before a product is mounted, the product is directly put in a support plate mounted on a wall surface preset with a mounting hole (FIG. 1); and then, the inner frame is rotated, so that the transmission rod and the pull rod drive the leg to be clamped on the support plate (FIG. 2). When to demount the product, the elastic sheet on the inner frame is pulled up, and the inner frame is rotated reversely to demount the product. To avoid falling off, the product has to be held.

The above gives a detailed description for the preferred embodiments of the present patent; however, the present patent is not limited to the above embodiments. Within the knowledge owned by the ordinary skill in this field, various changes can be made without departing from the objective of the present patent.

Finally, it should be noted that: the above are preferred embodiments of the present disclosure merely and are not intended to limit the present disclosure; although the present disclosure has been described in detail by reference to the above mentioned embodiments, for those skilled in the art, modifications also can be made to the technical scheme recorded in each embodiment mentioned above, or part technical features can be substituted equivalently. Any modifications, equivalent substitutes and improvements, etc., made within the spirit and principle of the present disclosure all are included in the scope of protection of the present disclosure.

What is claimed is:

1. An assembly and disassembly device for ceiling equipment, comprising an inner frame, an outer frame, a leg, a pull rod, a transmission rod, a cover plate and an elastic sheet, wherein the outer frame is disc shaped and has the inner frame disposed therein, the outer frame has four legs disposed equally spaced at the periphery thereof, furthermore, the inner frame has the cover plate mounted therein, the cover plate has the transmission rod disposed thereon, and the transmission rod is connected to the pull rod, wherein the inner frame can be rotated so that the cover plate is driven to rotate, as a result the transmission rod drives the pull rod and the pull rod drives the leg to be clamped on a support plate mounted on a wall surface preset with a mounting hole.

2. The assembly and disassembly device for ceiling equipment according to claim 1, wherein the angle of rotation of the inner frame is limited by the elastic sheet.

3. The assembly and disassembly device for ceiling equipment according to claim 1, wherein the ceiling equipment includes light-fixtures, exhaust fans or ceiling loudspeakers.

4. The assembly and disassembly device for ceiling equipment according to claim 2, wherein the ceiling equipment includes light-fixtures, exhaust fans or ceiling loudspeakers.
